(19) United States
(12) Patent Application Publication
(10) Pub. No.: US 2011/0219545 A1
(43) Pub. Date: Sep. 15, 2011

(54) BED, PARTICULARLY A HOSPITAL BED OR CARE NURSING BED

(76) Inventors: Günther Dorenbeck, Solingen (DE); Pascal Charles Antoine Poyet, Ile Maurice/Muritius (FR)

(21) Appl. No.: 13/127,394

(22) PCT Filed: Oct. 28, 2009
(86) PCT No.: PCT/EP2009/064228

§ 371 Date: May 3, 2011

(30) Foreign Application Priority Data
Nov. 3, 2008 (EP) 08168176.9

(51) Int. Cl. A61G 7/015

(52) U.S. Cl. 5/611; 5/618

(57) ABSTRACT

The invention relates to a bed (10), particularly a hospital or nursing bed, which is provided with a bed frame (20) that comprises two side portions (26) on the lateral sides, a head end (21), and a foot end (23). Furthermore, the bed (10) is provided with a mattress support structure (30), which comprises a back section (32) that can be adjusted, a seat surface section (34,36), and a lower leg section (38) that can be adjusted, and with a base (12) under the bed frame (20), wherein the base (12) comprises an end (15) on the foot end side that faces the foot end (23) and an end (17) on the head end side that faces the head end (21). The mattress support structure (30) is divided into a section (30b) on the foot end side and a section (30a) on the head end side along a dividing plane (44) extending substantially parallel to the foot and head parts (24,22) of the bed frame (20). The bed frame (20) is divided into a bed frame section (20b) on the foot end side and a bed frame section (20a) on the head end side along a dividing plane (45) extending substantially parallel to the dividing plane (44) of the mattress support structure (30). The sections (20b,30b) of the bed frame (20) and mattress support structure (30) on the foot end side can be optionally locked on the respective associated sections (20a,30a) thereof on the head end side or moved relative to said parts on the head end side. The bed frame (20) and the base (12) can be moved longitudinally, particularly by motor, relative to each other in a longitudinal direction parallel to the side portions (26) of the bed frame (20), namely between a first and a second relative movement position, wherein in the first relative movement position, the dividing plane (44) of the mattress support structure (30) is located in the area between the ends (15,17) of the base (12) on the foot end and head end sides, and wherein in the second relative movement position, the dividing plane (44) of the mattress support structure(30) is substantially aligned with the end (15) of the base (12) on the foot end side or is located between the end (15) of the base (12) on the foot portion side and the foot end (23) of the bed frame (20).

The present invention relates to a bed, particularly a hospital bed or a nursing bed.

Particularly for older persons or for persons who are ill or in need of care, there exist hospital beds or care beds which comprise height-adjustable bases and adjustable mattress supports. These bed offer a maximum level of comfort to the persons or patients and to the hospital or care personnel.

Depending on the degree of immobility of the person using such a bed, it may nonetheless happen to be bothersome to get up from the bed without assistance. This is because the person first has to move into a sitting position with his/her upper thighs resting on the edge of the bed, in order to then be able to get up into a standing position.

For facilitating the process of getting up from the bed, it is known from JP-A-2000042053 and US-A-2004/0226093 to laterally displace the back section and the seat-surface section of the mattress support structure relative to the lower-leg section of the mattress support structure, namely selectively beyond one of the two side portions of the bed frame. In the resultant laterally displaced state of the back section and the seat-surface section of the mattress support structure, it is required to provide a support to the seat-surface section and respectively a lateral support of the base or bed frame, so as to prevent the risk of a lateral tilting of the bed.

From WO-A-2008/087288, WO-A-2008/090278 and WO-A-2008/087289, it is further known that the lower-leg section of the mattress support structure of a bed are laterally displaced beyond the bed frame relative to the back and seat-surface sections of the mattress support structure. Further, from the above mentioned documents and from DE-A-288 612 and U.S. Pat. No. 4,805,249, it is known to arrange the lower-leg section of the mattress support structure of a bed to be laterally pivoted about a vertical axis relative to the remaining portion of the bed and, respectively, to provide the lower-leg section in a two-part configuration, wherein the two parts arranged on both sides of the central longitudinal axis of the bed and are each articulated to the remaining portion (region on the side of the head portion) of the bed.

Further, it is known, e.g. from EP-B-0 744 934, to pivot the lower leg section of the mattress support of a hospital or nursing bed in a downward direction in order to allow the person to get up out of bed via the foot of the bed, as is the case in the beds mentioned and described above.

Modern hospital and nursing beds comprise a base, particularly of the height-adjustable type, which holds the bed frame on it and which normally has four support legs resting on the ground. The support legs on the side of the head portion define the head-end-side end of the base, and the support legs on the side of the foot portion define the foot-end-side end of the base. For safety reasons, these ends of the base, arranged in the longitudinal dimension of the bed, are not allowed to exceed a certain maximum distance to the head portion and respectively the foot portion of the bed frame; otherwise, there would exist the risk that the bed, when subjected to vertical loads, might tilt onto the head and respectively foot portion. The lower-leg section of the mattress support structure of such beds normally has such a large extension between the foot portion of the bed frame and the seat-surface section of the mattress support structure that the connecting plane between the lower-leg section and the seat-surface section is arranged above the base between the two ends of the latter. Lower-leg sections of such an extension in the longitudinal direction of the bed are comfortable, notably so that grown-up persons, irrespective of their height, can support on the lower-leg section all of their lower legs from the knee joint downward.

In a situation when it would be intended, in the above described known hospital or nursing bed, to laterally displace the lower-leg section or, in another manner, to pivot the same relative to the rest of the bed or to remove it from the bed in order to make it easier for the person lying in the bed to sit up on the bed via the foot end, the foot-end-side regions of the base would still be in the way.

Finally, it is known from JP 03 063329 U, EP-A-0 178 951 and WO-A-2005/027813, that, in a bed comprising a foot portion which does not project upward beyond the lie-down surface, the mattress support structure can be displaced relative to the base beyond the foot end until the lower-leg section of the mattress support structure extends beyond the foot end and is directed downward. In this position, the back section can be folded up and the seat section can be inclined in the forward direction, resulting in the configuration of an easy chair with stand-up aid.

Thus, it is an object of the invention to provide a bed, particularly a hospital bed or nursing bed, which can be adjusted in a simple manner into a configuration allowing a person to sit up on the bed or to be sat down on the bed via the foot end of the bed in a convenient manner.

For achieving the above object, the invention proposes a bed, particularly a hospital bed or nursing bed, comprising
a bed frame comprising two side portions on the lateral sides, a head end and a foot end,
a mattress support structure comprising an adjustable back section, a seat-surface section and an adjustable lower-leg section, and
a base arranged below the bed frame, said base comprising a foot-end-side end facing toward the foot end, and a head-end-side end facing toward the head end.

In the above bed, ii is provided, according to the invention,
that the mattress support structure is subdivided, along a subdivision plane extending substantially parallel to the head and foot portions of the bed frame, into a foot-end-side section and a head-end-side section,
that the bed frame is subdivided, along a subdivision plane extending substantially parallel to the subdivision plane of the mattress support structure, into a foot-end-side bed frame section and a head-end-side bed frame section,
that the foot-end-side sections of the bed frame and of the mattress support structure are selectively lockable to their respectively associated head-end-side sections or moveable relative to said portions, and
that the bed frame and the base are longitudinally displaceable relative to each other, particularly in a motorized manner, in a longitudinal direction extending parallel to the side portions of the bed frame, said displacement being performed between a first and a second relative displacement position,
where, in said first relative displacement position, the subdivision plane of the mattress support structure is located in the region between the foot-end-side and head-end-side ends of the base, and
where, in said second relative displacement position, the subdivision plane of the mattress support structure is substantially in alignment with the foot-end-side end of the base or is located between the foot-end-side end of the base and the foot portion of the bed frame.

In essence, thus, it is provided according to the invention that, relative to the base, which is particularly of the height-adjustable type, the bed frame is arranged for displacement in the longitudinal direction of the bed. Namely, it will then be possible, for use of the bed in the manner of a piece of seating furniture (i.e. for assisting the person in stepping out of the bed via the foot end), to first displace the bed frame and the base relative to each other until the subdivision frames of the bed frame and of the mattress support structure are located outside the region occupied by the base. This relative displacement of the bed frame and the base is preferably performed in a motorized manner.

The starting point of the invention is a bed with a bed frame which comprises two side portions on the lateral sides, a head end optionally provided with a head portion, and a foot end optionally provided with a foot portion. Supported on the bed frame is a mattress support structure which is of a three- or four-part configuration and is adjustable. The mattress support structure comprises at least one adjustable back section, an adjustable lower-leg section and, between said back section and said lower-leg section, a seat-surface section which is fixed or movable or partially movable. According to a preferred embodiment of the invention, the seat-surface section can comprise two parts, namely and upper-leg section and a seat or lower-back portion. Suitably, said upper-leg section is adjustable and is articulated to the lower-leg section.

The bed frame is supported by a base which in the longitudinal direction of the bed is delimited by a foot-end-side end and a head-end-side end. Normally, the base will rest on the ground by head-end-side and foot-end-side support means. The base can be moveable, i.e. be provided with casters, which, however, is not absolutely required. Further, the base can be suitably height-adjustable.

In a normal hospital or nursing bed, neither the bed frame nor the mattress support structure are subdivided in a manner allowing a user to move a portion of the bed frame away from the rest of the bed frame structure or to move a portion of the mattress support structure away from the rest of the mattress support structure. According to the invention, however, this is now possible in that the mattress support structure as well as the bed frame are subdivided, along respectively one subdivision plane, into respectively one foot-end-side section and one head-end-side section. The two subdivision planes having arranged on their two sides the head-end-side and foot-end-side sections, can coincide with each other or extend parallel to each other at a small mutual distance.

Further, the invention provides the already mentioned displaceability of the bed frame and the base relative to each other. If the hospital bed or nursing bed is used as a normal bed, the bed frame and the base are in a first relative displacement position. In this first relative displacement position, the subdivision plane of the mattress support structure (as holds true, in the normal case, also for the subdivision plane of the bed frame) are located in the region between the foot-end-side and head-end-side ends of the base. To make it now possible, in the displaced condition of the foot-end-side sections of the bed frame and the mattress support structure, to conveniently get out of the bed or to conveniently sit down into the bed, it is provided according to the invention to move the bed frame and the base relative to each other into the second relative displacement position wherein the sub-division plane of the mattress support structure (and optionally also the subdivision plane of the bed frame) is outside the region occupied by the base. In this relative displacement position, that end of the seat-surface section of the mattress support structure which is facing towards the lower-leg section is arranged level with, or before or behind the foot-end-side end of the base. In any case, the position of the seat-surface section is such that, now, when the person wishes to get up from out of the bed, no regions of the foot-end-side end of the base are located anymore in the space below the front end of the seat-surface section facing toward the lower-leg section.

Thus, in other words, in the second relative displacement position, the subdivision plane of the mattress support structure is substantially in alignment with the foot-end-side end of the base. In this context, the term “substantially in alignment” means that the subdivision plane is located directly above the foot-end-side end of the base or slightly before and respectively slightly behind it. When arranged before the foot-end-side end of the base, the subdivision plane of the mattress support structure is located between the foot-end-side end of the base and the foot portion of the bed frame, while the subdivision plane of the mattress support structure is located in the position behind the foot-end-side end of the base between this foot-end-side end and the head-end-side end of the base.

As already mentioned above, various possibilities exist for moving the foot-end-side sections of the mattress support structure and of the bed frame together relative to the rest of the bed in such a manner that the egress from the bed via the foot end of the bed (which now is not in the way anymore) will be possible. For allowing the person to sit up on the bed, the back section and the seat-surface section can be brought into a chair- or easy-chair-like configuration, wherein, for further assistance in the sitting-up movement, the seat-surface section can be slightly tilted upward so as to support the lower legs in the region of the hollow of the knee. Further still, for added assistance, the thus formed chair or easy chair can be brought into a forwardly inclined position by tilting the bed frame. Such types of stand-up assistance are basically known from chairs or easy chairs. What is novel, however, is the integration of the stand-up assistance into a conventional bed. The foot-end-side sections of the mattress support structure and of the bed frame can either be laterally displaced beyond the lateral sides of the bed frame or be pivoted toward the outside about a vertical axis or, in case that these sections of the mattress support structure and of the bed frame are subdivided into various sub-portions, about several vertical axes. Also a pivoting movement into an obliquely laterally upward direction is possible. Finally, it can also be provided that the foot-end-side sections of the mattress support structure and of the bed frame are displaceable or movable so far that they have no connection anymore to the rest of the sections of the mattress support structure and of the bed frame. In this case, the foot-end-side sections of the mattress support structure and of the bed frame should also be supported on a dedicated foot-end-side part of the base, which part can then also be completely moved away from the rest of the base.

Suitably, the foot-end-side section of the bed frame has a dedicated support towards the ground on which the whole bed is resting. Such a support can be provided in the form of support legs with casters or spherical rollers for facilitating a movement of the foot-end-side sections of the mattress support structure and of the bed frame on the ground. In case of a height-adjustable base, the support of the foot-end-side section of the bed frame will be effective particularly when the base is located at its minimal height. The support of the foot-end-side section of the bed frame towards the ground is suitable particularly in the second relative displacement position of the bed frame and the base. When the bed, or the bed frame and the base, assume a different relative displacement position, the support elements and respectively the support can also be disabled, which can be performed e.g. by folding up or removing the support elements.

For safety reasons, it should be suitably provided that the inventive bed can be raised by means of a height-adjustable base only if the bed frame and the base are in the first relative displacement position. Namely, in this situation, the bed frame is supported on the ground with maximum stability. In other words, this means that the height-adjustability of the base will be allowed only in the first relative displacement position of the bed frame and the base. Put differently, this is to say that, then, also the longitudinal displaceability of the bed frame and the base can be realized only if the base is located at its minimal height. This statement is to pertain also to the case that, in the second relative displacement position of the bed (and thus in a situation where the foot-end-side sections of the mattress support structure and of the bed frame have been possibly moved away) the base can be slightly raised, notably to the effect that the seat-surface section will be at a “comfortable” height, as known from chairs and easy chairs, for the person to sit up on the bed or be sat down on the bed.

By the subdivision of the bed frame, the side portions thereof are respectively of a two-part configuration and are subdivided into a foot-end-side section and a head-end-side section. For stiffening these side portions of the bed frame in any relative displacement position of the bed other than the second relative displacement position, there is suitably provided a stiffening element extending on both sides of the subdivision plane of the bed frame and will be immersed into the two sections of the respective side portion if the bed frame and the base assume a relative displacement position other than the second relative displacement position. The stiffening elements can be provided for manual actuation and thus be movable by hand. By way of alternative, it can be provided that the stiffening elements will be automatically released from their engagement with the two foot-end-side sections of the side sections of the bed frame when the bed frame and the base assume their second relative displacement position. For this purpose, the stiffening elements are arranged in fixed positions relative to the base or the bed frame, depending on whether the base can be actively displaced relative to the bed frame or the bed frame can be actively displaced relative to the base.

Suitably, the stiffening elements are respectively formed as pins, wherein, on both sections of each side portion of the head-end-side bed frame section, a respective guide channel is arranged for guiding the respective pin and, on the foot-end-side section of the side portion, a receiving channel is arranged for receiving the pin, and wherein, during the relative displacement of the bed frame and the base, the pins are located in the guide and receiving channels, while, in the second relative displacement position, they will be located outside the receiving channels.

To prevent an unintended movement of the foot-end-side bed frame section relative to the head-end-side section when the bed frame and the base are in their second relative displacement position, there is suitably provided a locking element, particularly of the tape for manual activation and release, for moving the foot-end-side bed frame section.

The connection between the respective head- and foot-end-side sections of the bed frame and of the mattress support structure is suitably realized by joints, with their joints axes extending substantially parallel to the subdivision planes and transverse to the direction of the longitudinal displacement of the bed frame and the base. The joints herein can advantageously be C-shaped profiled members gripping around cylindrical profiled members. Advantageously, a joint of this type will—by its design-inherent configuration—delimit the pivoting angle which is defined by the opening of the C-shaped profiled member and the thickness of a connection element connected to the cylindrical profiled member. By the C-shaped and cylindrical profiled members, the head- and foot-end-side sections of the bed frame and of the mattress support structure are also displaceably guided on each other.

The axis of said joint between the two sections of the bed frame suitably extends above the side portions of the bed frame.

As already briefly mentioned above, the lower-leg section of the mattress support structure is articulated to the seat-surface section. In case that the seat-surface section itself is of a two-part configuration and comprises an upper-leg section as well as a seat or lower-back section, the articulated connection is realized between the lower-leg section and the upper-leg section. The lower-leg section is supported on the foot-end-side section of the bed frame and, when the foot-end-side section of the bed frame is moved, will be entrained by the latter. The lower-leg section can folded upward while taking along the upper-leg section and respectively the seat-surface section, and in a folded-up position it can be supported by adjustable support members. These adjustable support members are suitably formed in the manner of adjustable support scissors comprising two intersecting bars extending transversely to the side portions of the bed frame, said bars having their ends displaceably and pivotally connected to the foot-end-side sections of the mattress support structure and of the bed frame and being selectively lockable in any one of a plurality of mutually intersecting oblique positions. By said transversely mounted support scissors, the foot-end-side sections of the bed frame and of the mattress support structure are connected with stiffness against pushing forces and with shear resistance.

As also mentioned above, for transfer of the bed from the first relative displacement position to the second relative displacement position, it can either be provided that the bed frame is displaceably arranged on the base or, however, that the base is displaceably arranged on the bed frame. In the latter case, the base is suitably configured for longitudinal displacement, i.e. is telescopable relative to a (horizontal) plane arranged parallel to the ground. Suitably, the head-end-side end of the base is connected to the bed frame so as to prevent displacement relative to the latter, whereas the foot-end-side end of the base is coupled to the bed frame for longitudinal displacement. Thus, starting from the first relative displacement position, the base will be folded together or collapsed so that, finally, in the second relative displacement position, the foot-end-side end of the base will be substantially in alignment with the subdivision plane of the mattress support structure (in these sense as defined herein and explained above).

Finally, the above mentioned object is also achieved by a bed comprising
a bed frame comprising two side portions on the lateral sides, a head end, and a foot end,
a mattress support structure comprising an adjustable back section, a seat-surface section and an adjustable lower-leg section, and
a base arranged below the bed frame, said base comprising a foot-end-side end facing toward the foot end, and a head-end-side end facing toward the head end.

Therein, it is then provided
that the mattress support structure is subdivided, along a subdivision plane extending substantially parallel to the head and foot portions of the bed frame, into a foot-end-side section and a head-end-side section,
that the bed frame is subdivided, along a subdivision plane extending substantially parallel to the subdivision plane of the mattress support structure, into a foot-end-side bed frame section and a head-end-side bed frame section,
that the foot-end-side sections of the bed frame and of the mattress support structure are selectively lockable to their respectively associated head-end-side sections or moveable relative to said portions, and
that the foot-end-side section and the head-end-side section of the bed frame are supported by a foot-end-side section and respectively a head-end-side section of the base, the bed frame and the base being connected to each other in a manner securing them against longitudinal displacement, and the foot-end-side sections of the bed frame and the base being movable relative to each other in relation to the head-end-side sections of the bed frame and the base.

According to the invention, it is thus proposed that the foot-end-side end of the bed frame together with the associated lower-leg section of the mattress support structure (and with the corresponding section of the mattress which for this purpose is of a two-part configuration) can be separated from the rest of the bed. To make this possible, it is proposed in accordance with the invention that the respective foot-end-side ends of the bed and of the mattress support structure will be laterally displaced, separated from the bed in the longitudinal direction of the bed, pivoted upward and to the side, or, in case of a configuration of the foot end that is split along the longitudinal axis, the two sections of the foot end will be pivoted respectively laterally outward and/or upward or the like.

It is, however, of advantage if the foot-end-side section of the bed frame together with the foot-end-side section of the mattress support structure can be shifted to the side, notably by an extent which makes it possible that, in the laterally displaced condition, these foot-end-side sections will still remain connected to and guided by the head-end-side sections of the bed frame and the mattress support structure.

The already described lateral displaceability of the foot-end-side section (hereunder referred to as the foot end) of the bed cannot be realized without further measures since both the bed frame and the mattress support structure have to be subdivided correspondingly. In this regard, concerning the mattress support structure, use can be made of the relative displaceability thereof between the lower-leg section and the upper-leg section or, generally, the seat-surface section. These two parts are normally articulated to each other wherein, particularly, the upper-leg section can be pivoted in a motorized manner, with the consequence that the lower-leg section which is articulated thereto will be “dragged along” with it. Thus, when the upper-leg section is pivoted, the lower-leg section will be raised in the region of the joint to the lower-leg section.

One could now consider to unlock this articulated connection in a well-aimed manner or to release the connection in some other way, in order to laterally displace the foot end of the bed relative to the rest of the bed. This, however, would cause the difficulty that then, when the foot end subsequently is to be pushed back again, the articulated connection would have to be reestablished, which would considerably affect the ease of operation.

Therefore, with regard to the lateral displaceability of the foot end of the bed, it is provided that the lower-leg section is guided for lateral displacement on the seat-surface section of the mattress support structure, which is realized by the cooperation of a first guiding profile member on the seat-surface section or the lower-leg section, and a first bearing element as well as a first connection element on the lower-leg section and respectively the seat-surface section, wherein the first bearing element is accommodated in the first guiding profile member in a manner allowing for longitudinal displacement and, via the first connection element extending through a lateral opening in the first guiding profile member, is connected to the lower-leg section and respectively the seat-surface section of the mattress support structure. Said opening is dimensioned such that its edges, arranged in the circumferential direction around the axis of the joint, will not impede the pivoting of the upper-leg section and the lower-leg section within the desired pivoting range.

Thus, in other words, the upper-leg section and the seat-surface section (or the upper-leg section and the seat part of a two-part seat-surface section) are connected to each other by a hinge which, apart from the pivoting, also allows for lateral displacement of the two sections of the mattress support structure.

Also the two head- and foot-end-side sections of the bed frame (the foot end and the rest of the bed frame, said rest hereunder being referred to as the head end, for reasons of brevity) are guided for displacement relative to each other. In this regard, either the foot end or the rest of the bed frame is provided with a second guiding profile accommodating a second bearing element which via a lateral opening in the second guiding profile member can be connected to the respective other parts of the bed frame. For this purpose, a second connection element is provided. Thus, the longitudinal displaceability of this connection of the two parts of the bed frame is realized in a manner similar to the one described above with respect to the connection of the upper-leg section and the lower-leg section of the mattress support structure. However, the connection between the two bed frame sections does not necessarily require that they are pivotable. On the other hand, also in regard to this connection, a corresponding ability to pivot, as described above in the context of the connection of the upper-leg section and the lower-leg section, can be provided.

The pivotability of the laterally displaceable joint connection of the upper-leg section and the lower-leg section is suitably realized in that the first guiding profile member comprises a C-shaped profile gripping around the first bearing element which is formed as a cylindrical body. Through the opening of the C-shaped profile, one can then guide the connection element between the first bearing element and the corresponding other part of the mattress support structure. Said opening is formed to extend along the complete length of the first guiding profile member, as is the case in C-shaped profiles or other profiles which have a slot or a similar opening.

However, it can also be provided that said opening which is required for the articulated and laterally displaceable connection of upper-leg section and lower-leg section is terminated in the first guiding profile member before the end faces of the latter. These ends of the opening will then serve as stoppers for limiting the lateral displaceability of both parts.

The advantage of the inventive construction, wherein it is generally provided that the foot end of the bed frame can be at least partially moved away, is to be seen in that the person lying in the bed can now get up in a considerably easier manner. Notably, after the foot end has been removed, the person lying in the bed will automatically assume a sitting position when the back section of the mattress support structure has been adequately folded upward. In case that the laterally displaced foot end is further provided with lateral safety portions, as is to be expected in hospital and nursing beds, the person in the process of sitting up on the bed can support himself or herself on these upright lateral safety portions, with the person using one hand for gripping the lateral safety portion—facing toward the person—of the moved-away foot end, and the other hand for gripping the lateral safety portion which is located on the other longitudinal side of the bed frame beside the pelvis region of the person. Thus, these two lateral safety portions can be used in the manner of armrests of chairs, notably both for allowing the person to get up out of bed and for allowing the person to lower himself or herself onto the bed so as to assume a sitting posture. Alternatively, support armrests can be mounted to the sides of the seat-surface section (e.g. by means of a plug-on connection).

In its most general form, the invention relates to a hospital bed or nursing bed, comprising
a bed frame comprising two side portions on the lateral sides, a head end, and a foot end,
a mattress support structure comprising an adjustable back section, a seat-surface section and an adjustable lower-leg section, and
a base arranged below the bed frame, said base comprising a foot-end-side end facing toward the foot end, and a head-end-side end facing toward the head end,
wherein the mattress support structures of the bed frames are subdivided respectively into a foot-end-side section and a head-end-side section which are arranged on both sides of mutually parallel and displaced or mutually coinciding subdivision planes extending substantially at right angles to the longitudinal direction of the bed, and
where the bed frame and the base are displaceable/moveable relative to each other in the longitudinal direction of the bed in such a manner that the subdivision plane(s) extends/extends through the base or outside the base and respectively at the height of the foot-end-side end of the base.

The invention will be explained in greater detail hereunder by way of several embodiments. In the individual Figures, the following is shown:

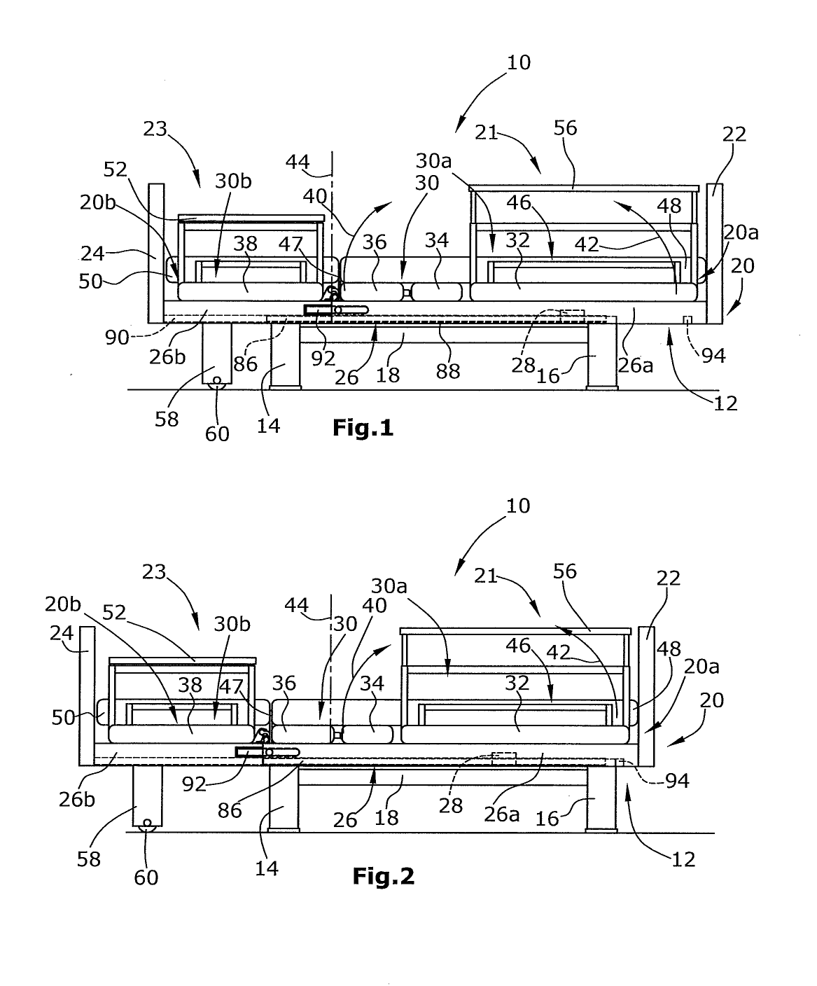

FIG. 1 is a schematic lateral view of a hospital or nursing bed comprising a bed frame split along vertical planes and with split mattress support structure, the bed frame being illustrated in its normal displacement position relative to the base,

FIG. 2 is a further view of the bed of FIG. 1, wherein, however, the bed frame has now been displaced relative to the base so far that the subdivision plane of at least the mattress support structure is located outside the region occupied by the base,

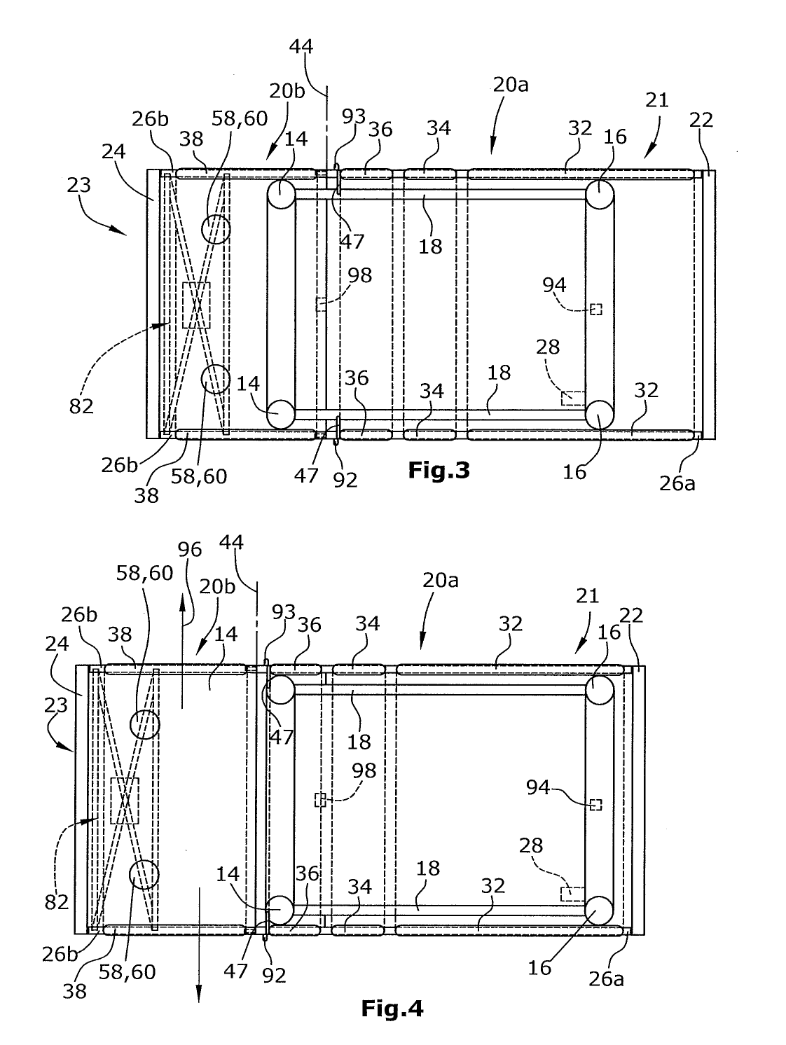

FIG. 3 are plan views of the bed in the positions according to FIGS. 1 and 4 and 2,

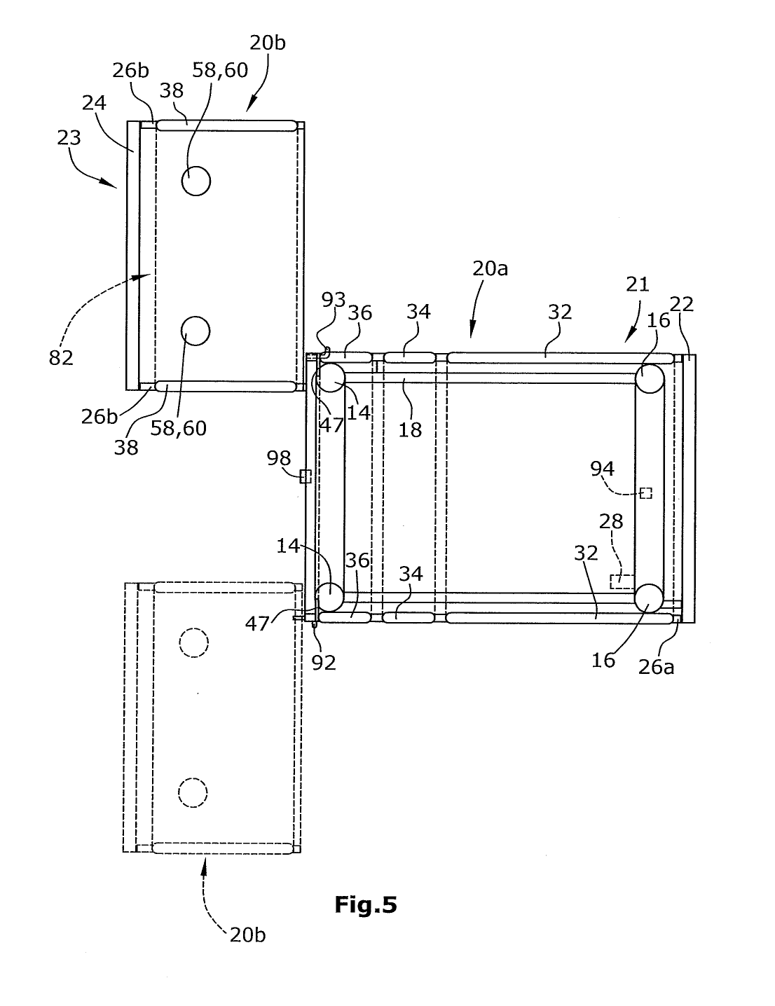

FIG. 5 is a plan view of the bed in its displacement position according to FIG. 2, illustrating the lateral displaceability of the foot end of the bed (foot-end-side section of the bed frame and of the mattress support structure),

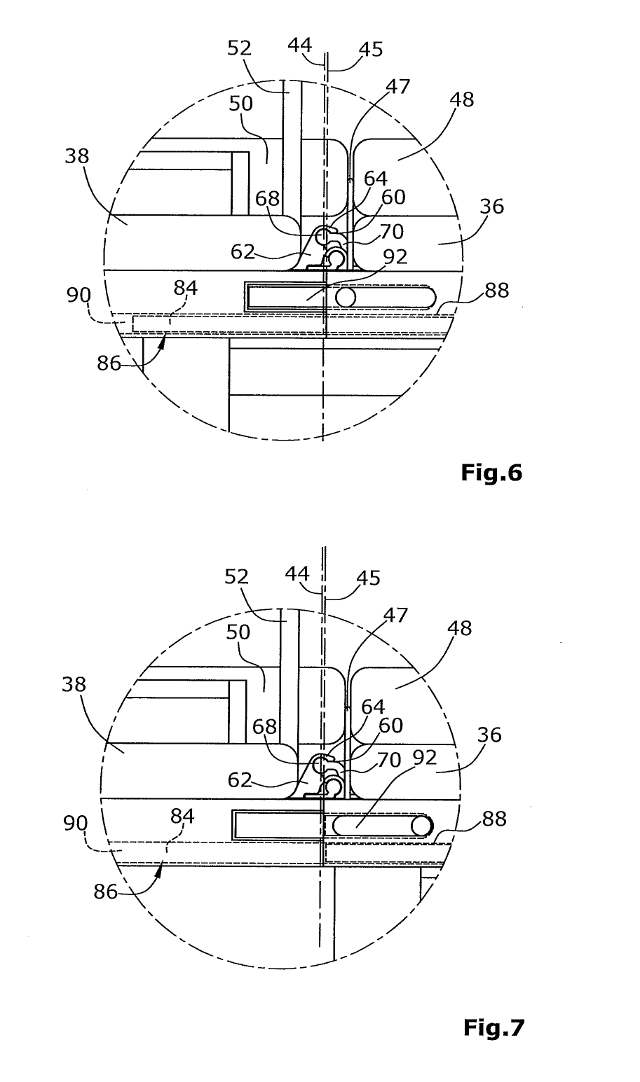

FIG. 6 is a detailed view of the connection of the two bed frame sections and the two mattress support structures in the normal position of the bed,

FIG. 7 is a detailed view of the connection of the two bed frame sections and the two mattress support structures, with the bed arranged in the displacement position according to FIG. 2,

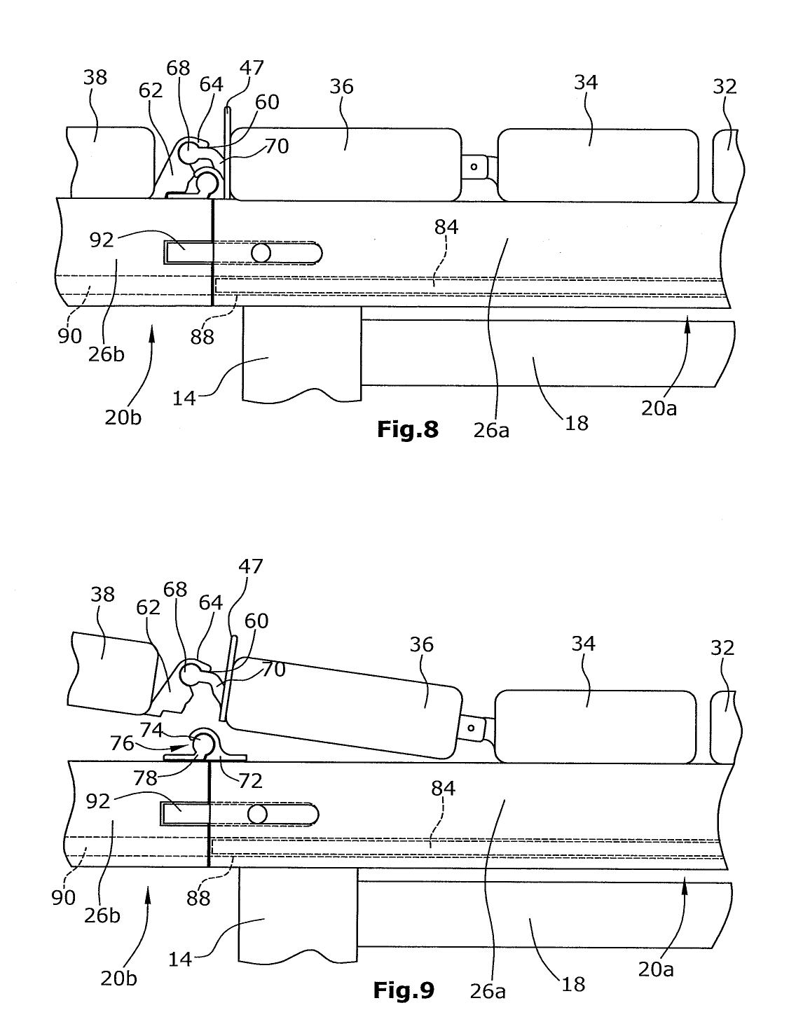

FIG. 8 is a view similar to FIG. 7, however with the bed frame sections still locked,

FIG. 9 is a view showing the situation wherein the lower-leg section and the upper-leg section of the mattress support structure are folded up relative to the seat-surface section,

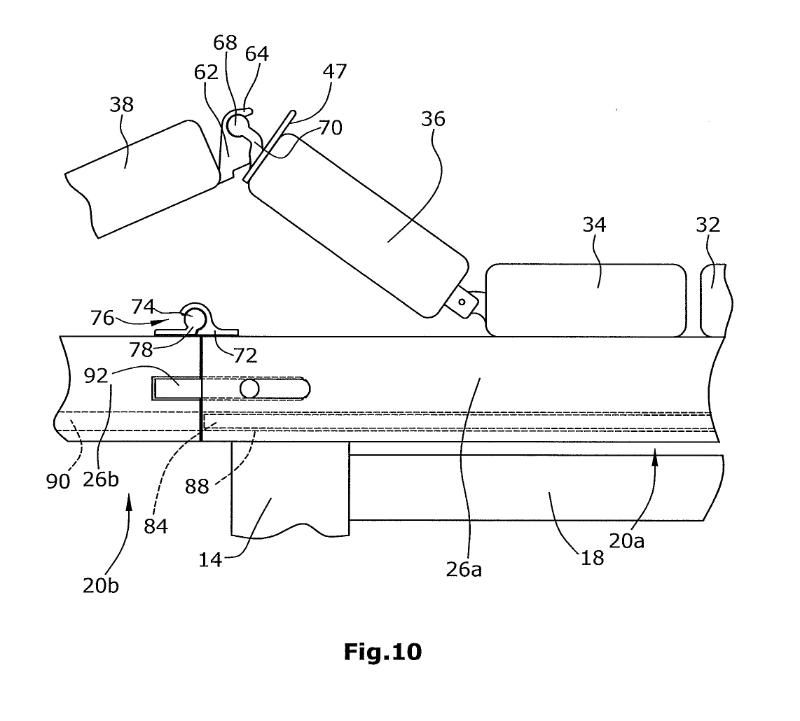

FIG. 10 is a view showing the situation wherein the lower-leg section of the mattress support structure has been raised in a motorized manner and the lower-leg section is oriented obliquely downward,

FIG. 11 is a perspective lateral view of the bed with laterally displaced foot end and with the mattress support structure in a position as in a chair or easy chair,

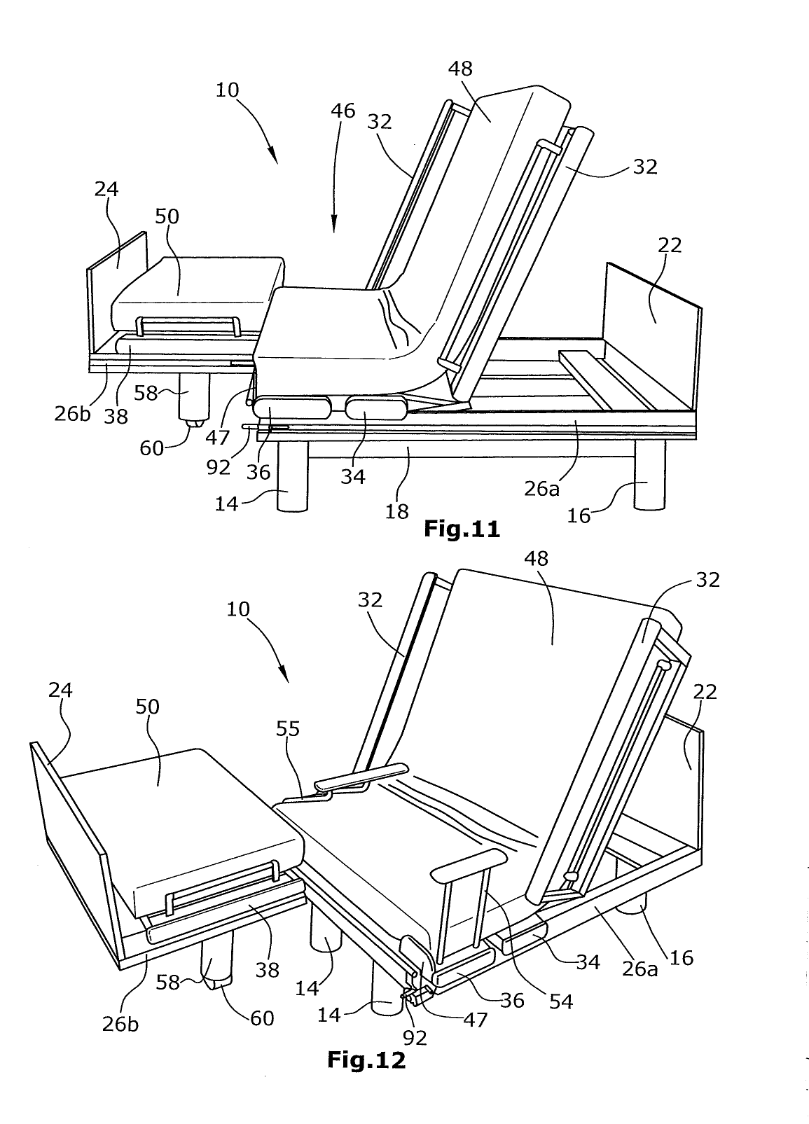

FIG. 12 is a different perspective view of the bed in the position according to FIG. 11,

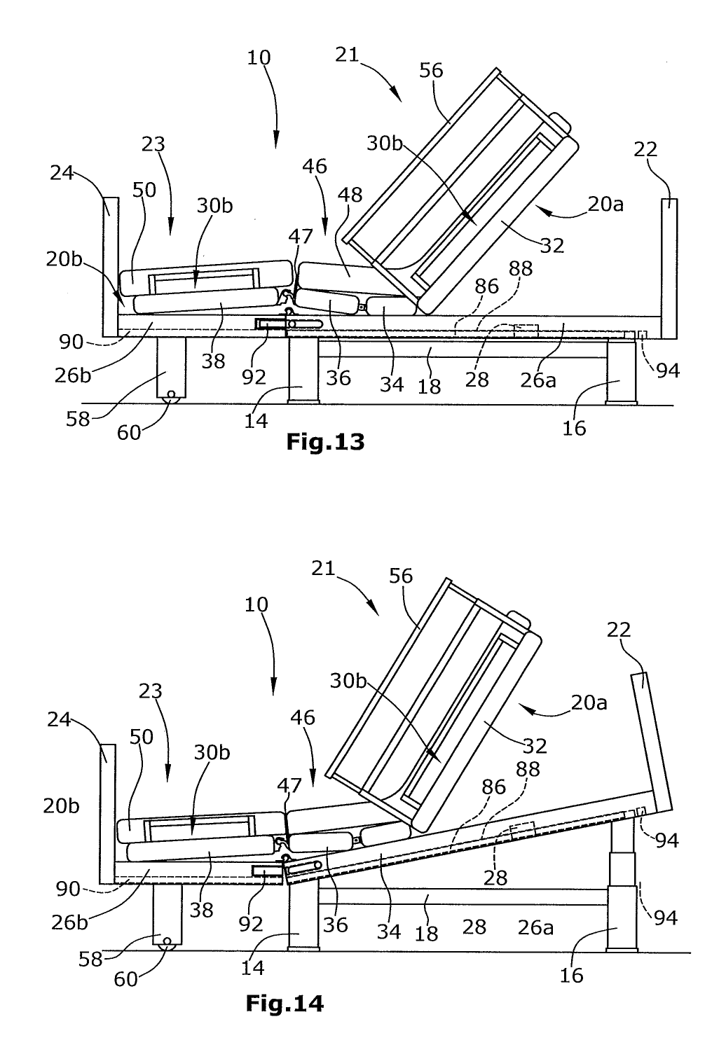

FIG. 13 is a side view of the bed in the positions according to FIGS. 11 and 12 for illustrating the raising of the lower-leg section which is possible in these positions,

FIG. 14 is a view of the situation of the bed with the mattress support structure in the positions according to FIGS. 11 to 13, wherein additionally, as a further stand-up assistance, the bed frame section supported by the base has been inclined,

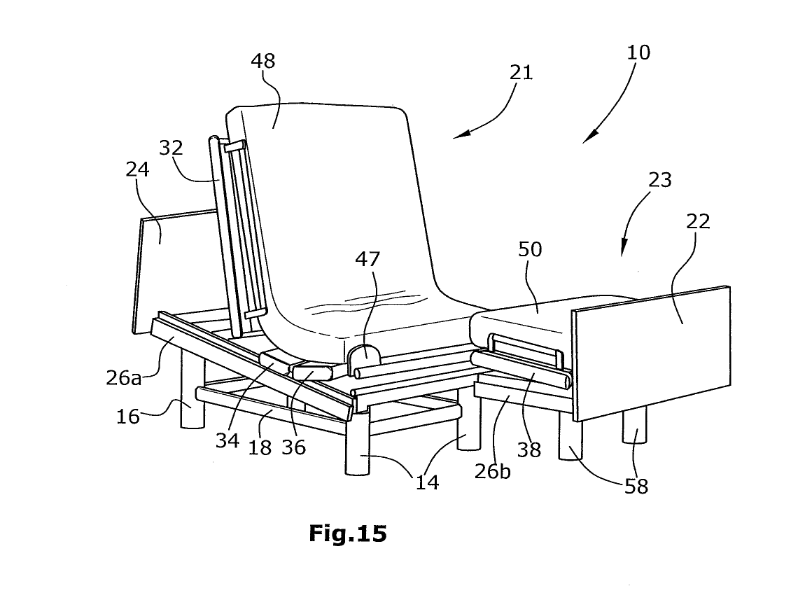

FIG. 15 is a further perspective view of the bed in the position according to FIG. 14,

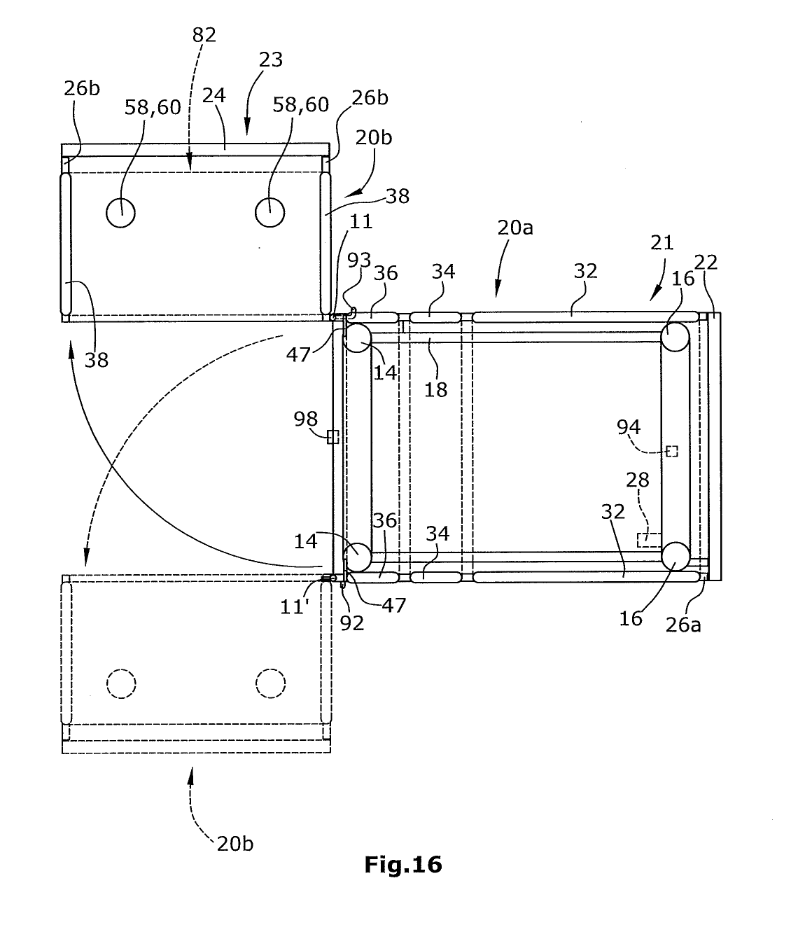

FIG. 16 is a plan view of an alternative embodiment of the bed in its displacement position according to FIG. 2, illustrating a lateral pivotability of the foot end of the bed about an axis which is vertical in the use condition of the bed,

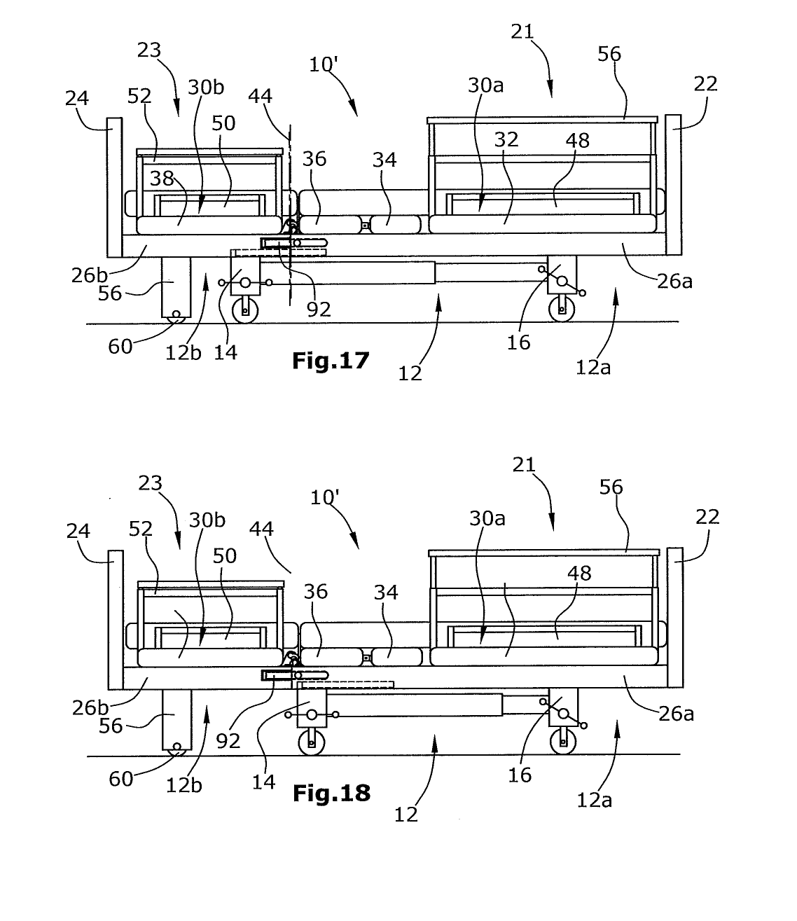

FIG. 17 is a lateral view of the bed according to an alternative embodiment with collapsible base, in the normal position of the bed,

FIG. 18 is a lateral view of the bed according to FIG. 17, with its base collapsed for lateral displacement of the foot portion of the bed,

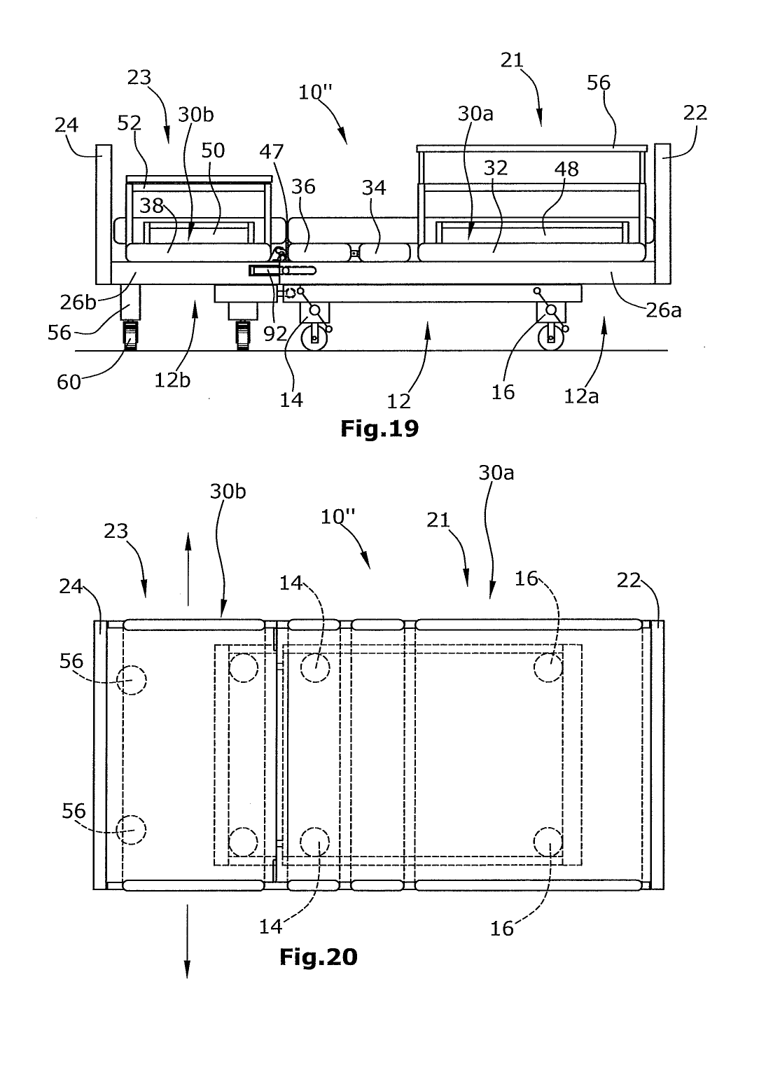

FIG. 19 is a view of a further embodiment of a bed wherein, apart from the bed frame and the mattress support structure, also the base is of a two-part configuration, and

FIG. 20 is a plan view of the bed according to FIG. 19 with schematically outlined displaceability of the foot portion of the bed.

FIGS. 1 to 10 schematically illustrate a hospital or nursing bed 10 which can be selectively used in the manner of a chair or easy chair, wherein the pivotable back section of the mattress support structure 30 can be used like the backrest of a chair and the split lateral safety portions can be used like the armrests of a chair.

The bed 10 comprises a base 12 which is height-adjustable. Said base 12 is provided with four support legs 14,16 (normally equipped with lockable casters) which are height-adjustable in a telescoping or another manner and on their upper ends are connected to each other by connection elements 18 (see also FIGS. 3 and 4). The head-end-side support legs 16 form the head-end-side end 17 of base 12 while the foot-end-side support legs 14 form the foot-end-side end 15 of base 12.

On said height-adjustable base 12, a bed frame 20 is supported for horizontal displacement. Bed frame 20 comprises a head portion 22 on the head end 21 of bed 10 and a foot portion 24 on the foot end 23 of bed 10. Said head portion 22 and said foot portion 24 are connected to each other by two side portions 26. The two side portions 26 are supported for displacement on the upper end of base 12. For automatic displacement of bed frame 20 relative to base 12, a motor 28 is provided.

Arranged within bed frame 20 is a (four-part) mattress support structure 30 comprising a pivotable back section 32, a fixed seat section 34, a pivotable upper-leg section 36 and a movable lower-leg section 38, wherein, by way of alternative, the upper-leg section and the seat section can also be combined into one adjustable seat-surface section, as is the case in three-part mattress support structures. The lower-leg section 38 is articulated to the upper-leg section 36 and, when the upper-leg section 36 is being pivoted (see arrow 40), will be moved along therewith while being raised on its (connection) end facing towards the upper-leg section 36 and thus being brought into an inclined position. In FIG. 1, the pivotability of back section 32 is schematically illustrated by arrow 42.

A particular feature of the bed according to FIGS. 1 to 10 is to be seen in the subdivision of the bed frame 20 and the mattress support structure 30 in the region of the subdivision planes 44 and 45 vertically illustrated in FIGS. 6 and 8. On both sides of subdivision plane 44, there is arranged, for each side portion 26 of bed frame 20, a head-end-side section 26a and a foot-end-side section 26b. The two thus formed bed frame sections, i.e. the head-end-side bed frame section 20a and the foot-end-side bed frame section 20b, are displaceable transversely to the longitudinal extension of the bed 10, namely in subdivision plane 44, as schematically shown in FIG. 5. Also the mattress support structure 30 is subdivided by subdivision plane 45 into a head-end-side section 30a and a foot-end-side section 30b. In the present embodiment, the head-end-side section 30a of the mattress support structure 30 comprises the back section 32, the seat section 34 and the upper-leg section 36 of the mattress support structure 30, while the foot-end-side section 30b comprises the lower-leg section 38. The subdivision can also be provided in a different manner. It should be mentioned that the two subdivision planes 44 and 45 can also coincide. This means that the articulated connection between lower-leg section 38 and upper-leg section 36 in subdivision plane 45 is arranged for lateral displacement.

The above mentioned lateral displaceability of the foot-end-side bed frame section 20b makes it possible to use the bed in the manner of a chair or easy chair so as to get up from bed 10 or to sit down on bed 10. During normal use of bed 10, as shown in FIG. 1, subdivision plane 44 is located in the region of base 12. If, in this condition of bed frame 20, one would displace the foot-end-side section 20b of bed frame 20, the regions of the base 12, i.e. the foot-end-side support legs 14, would be in the way. For this reason, it is provided that the bed frame 20 is horizontally displaceable relative to the base 12 (referring to the view of FIG. 1) until the subdivision plane 44 is located outside the region occupied by base 12 (see FIG. 2).

FIGS. 11 to 15 illustrate the position and setting of bed 10 for using the same in the manner of a chair or easy chair in the function of a stand-up aid. It can be seen that the mattress 46 resting on the mattress support structure 30 is of a two-part configuration and comprises a head-end-side section 48 as well as a foot-end-side section 50. Said foot-end-side section 50 of mattress 46 rests on the lower-leg section 38 of mattress support structure 30, and said head-end-side section 48 rests on the back section 32, the seat section 34 and the upper-leg section 36 of the mattress support structure 30 and, by means of enclosure elements 47, is secured against sliding toward the foot end 23 of bed 10. The lower-leg section 38 is provided with two lateral safety portions 52 which in FIGS. 1 and 2 are shown in the turned-up position in which they project beyond the upper side of mattress 46 laterally of the mattress. Shown in FIG. 12 are two armrest portions 54 and 55 which in the present embodiment are fixed to the bed frame 20, notably on the side section 26a thereof (e.g. by a plug-on connection or a similar releasable connection). Said armrest portion 54 extends upward in a substantially linear manner, while said armrest portion 55 first extends, starting from the bed frame side section, over the mattress 46 (or upward at a slight angle) until about the center of the seat surface and, from there, further upward. Also the back section 32 of mattress support structure 30 comprises two lateral safety portions 56. As evident from FIG. 13, it is now possible, for egress from the bed 10, to use the armrests 54 and 55 in the manner of the armrests of a chair for support during the process of sitting up or sitting down.

In FIGS. 1 to 10, it can be further seen that the displaceable foot end 23 of bed 10 is supported by support leg 58 with casters 60. This is not absolutely required for the invention but will facilitate the displaceability of the foot end 23 relative to the rest of the bed frame 20 comprising the head end 21. The support legs 58 can be adapted to be folded up or to be removed.

FIGS. 6 to 10 illustrate in greater detail how the connection of the parts of bed 10 arranged on both sides of subdivision planes 44 and 45 is realized. Particularly, the upper-leg section 36 of mattress support structure 30 comprises a frame 62 or the like which is provided with a first C-shaped guiding profile member 64 that is open toward the lower-leg section 38 of mattress support structure 30. Said first guiding profile member 64 has a C-profile, i.e. is provided with an opening 66 in the region of the side wall of the first guiding profile member 64. Arranged within the first C-shaped guiding profile member 64 is a displaceably guided first cylindrical profiled member 68 which is connected to the lower-leg section 38 via a first connection element 70. Said first connection element 70 extends through an opening 66 in the first guiding profile member 64. In this manner, it is rendered possible that, when the upper-leg section 36 is (actively) pivoted (see arrow 40 in FIG. 10), the lower-leg section 38 will be taken along and be pivoted as well. On the other hand, the lower-leg section 38, when being manually raised, is via the C-profile rigidly coupled to the upper-leg section 36 which thus will be raised as well (FIG. 9).

Nonetheless, due to the articulated connection between the upper-leg section 36 and the lower-leg section 38, these two parts can be laterally displaced relative to each other, as shown e.g. in FIG. 5. In this situation, the articulated connection will be maintained or, in other words, the advantage resides in that, after the return movement of the foot end 23 from the position according to FIGS. 1 to 4, there will automatically exist again the articulated connection between the upper-leg section 36 and the lower-leg section 38 as required for the inventive function of the mattress support structure 30. This functionality is automatically established without the need for special dexterity. This increases the convenience with respect to the handling of the bed.

Also in the bed frame 20, a cooperation is provided between a guiding profile member and a body guided therein, to the effect that the foot end 23 of bed 10 is laterally displaceable relative to the rest of the bed 10. For this purpose, the head-end-side bed frame section 20a comprises, on its end facing toward bed frame section 20b, a second guiding profile member 72 with C-profile having a second cylindrical profile element 74 displaceably guided therein. Said second guiding profile member 72 has an opening 76 in its side wall with a connection element 78 extending therethrough, which connection element is connected to bed frame section 20b.

From FIGS. 1 to 10, it is further evident that the lower-leg section 38 on its end facing towards the foot portion 24 of bed 10 can be supported on the sections 26b of the side portions 26 of bed frame section 20b via a slide or roller element 80. This support is realized on the inner sides of the sections 26b of bed frame 20. In this manner, the lower-leg section 38 will be guided on the bed frame, especially when the foot end 23 will be laterally displaced. In this process, namely, the lower-leg section 38 will be automatically taken along. Thus, the lower-leg section 38 and the bed frame section 20b of the foot end 23 of bed 10 can always be laterally displaced together, even though the force required for this displacement will be exerted only onto one of these two parts. A scissors-like raising construction 82 (the scissor-type adjustable supports being schematically shown in FIGS. 3 to 5) is arranged transversely to the longitudinal extension of the bed 10 between the bed frame section 20b and the mattress support structure section 30b. This raising construction 82 provides a connection between the lower-leg section 38 and the foot-end-side bed frame section 20b which is shear-resistant against lateral forces.

The lateral pivotability of the foot end 23 of the bed 10 has been described above with reference to the use of an articulated and respectively displaceable connection of the parts 20a and 20b of bed frame 20 and of the lower-leg and upper-leg sections 38,36 of the mattress support structure 30, with the profile members and bearing elements arranged on the bed frame section 20a and respectively the upper-leg section 36. Of course, this type of articulated and/or displaceable support can also be realized in an “inverted” manner, i.e. the guiding profile members 64,72 can be arranged on the lower-leg section 38 of the mattress support structure 30 and respectively on the foot-end-side bed frame section 20b of bed frame 20.

When raising the bed frame 20 by means of the height-adjustable base 12, it should be prevented that the foot end 23, once it is not supported anymore via the caster 60, can unintentionally swing down. This can be realized by a dedicated bar 84 which functions as a stiffening element 86. Such a bar 84 can be arranged in each side portion 26 of bed frame 20, said bar 84 being received by the two side sections 26a and 26b when the bed 10 is not in its displacement position according to FIG. 2, i.e., for instance, when the bed is in its displacement position according to FIG. 1 (see also the detailed views in FIGS. 6 and 7). Said stiffening elements 86 strengthen the connection between the two sections 26a and 26b of each side portion 26 of bed frame 20. They are connected to base 12 and are arranged in guiding channels 88 of the of the head-end-side sections 26a of the side portions 26. In the normal displacement position of the bed (see FIGS. 1 and 6), the stiffening elements 86 are immersed into receiving channels 90 of the foot-end-side sections 26b of the bed frame side portions 26, whereas, when the bed is in the position for lateral displacement of the foot end 23, the stiffening elements 86 will have been moved out from said receiving channels 90.

Additionally, on the side portions 26 of bed frame 20, locking elements 92,93, e.g. of the type for manual actuation, are provided which, when the bed is in the position for lateral displacement of the foot end 23, will secure the latter against undesired displacement; further, during the return movement, they will act as limiting stoppers.

Hereunder, the working principle and the way of handling the bed 10 will be explained in greater detail, again with reference to FIGS. 1 to 10.

Basically, it holds true that the relative displaceability of base 12 and bed frame 20 is possible only if the height-adjustable base 12 is in its minimal height position as shown in FIG. 1. When this position has been reached, this will be detected by one or a plurality of detectors (e.g. end switches, not illustrated). In this situation, the foot end 23 of bed 10 is supported via the support legs 58.

Now, if the bed 10 is to be brought into the configuration for egress from the bed at the foot end thereof, the mattress support structure 30 can first be transferred into the corresponding position by folding up the back section 32 and, optionally, moving the upper-leg section 36 into a slightly inclined position, as shown in FIGS. 11 to 15.

For lateral displacement of foot end 23, it is first required to displace the bed frame 20 relative to base 12 in the longitudinal extension of bed 10 until, starting from the normal position according to FIG. 1, the position according to FIG. 2 has been reached. This position is detected by detector 94. In this position (second longitudinal displacement position), the stiffening elements 86 will release the foot-end-side sections 26b of the side portions 26 of bed frame 20, which is also evident from a comparison between FIGS. 6 and 7. FIGS. 3 and 4 show plan views of the bed 10 in the normal position (first longitudinal displacement position according to FIG. 3) and in the second longitudinal displacement position according to FIG. 4. Lateral displaceability of foot end 23 is now still prevented only by the locking elements 92. From FIG. 4, it can be gathered that, for displacing the foot end 23 in the direction of arrow 96, the locking element 93 has to be released. Now, the foot end 23 of the bed can be displaced in the direction of arrow 96, as shown in FIG. 5. In this context, it should still be mentioned that the locking elements 92 and 93 engage the side sections 26b of bed frame 20 only from the outside. Thus, if one of the two locking elements 92,93 is unlocked, the foot end 23 of bed 10 can be laterally displaced beyond the respective locking element while the other locking element is still in its locking position but has no locking effect (see locking element 92 in FIG. 5). When the foot portion 23 of bed 10 is being moved back, the locking element 92 will serve as a stopper and will thus limit the displacement path of foot portion 23. The position of foot portion 23 outside its central position according to FIGS. 3 and 4 is detected by a detector 98. If this detector does not indicate the occupation of the central position of foot portion 23 of bed 10, a displacement of base 12 will be possible only to a height slightly above the minimal height (a few centimeters above it), so that the bed, which has been converted into a chair or easy chair, can be raised to a convenient seat height. A farther height adjustment of base 12 is prevented since, otherwise, the foot end 23 would not be supported anymore by its support legs 58, with the consequence that, in case of vertical loads, the raised bed might tilt onto the foot end 23 and in the worst case cause the foot end 23 to break off. Therefore, upon detection of the second longitudinal displacement position according to FIG. 2 by means of detector 94, is height-adjustability of base 12 is restricted to the above described slight displacement range.

Further, in the chair or easy-chair position of bed 10 according to FIGS. 11 to 15, the head-end-side bed frame section 20a can be brought into an inclined position (see FIGS. 14 and 15), thus further facilitating the egress from bed.

FIG. 16 shows an alternative bed 10′ in a view similar to the above mentioned FIG. 5 showing bed 10. Instead of the pivotability of the foot end of bed 10 of FIG. 1, the foot end of bed 10′ is pivotable about a vertical axis 11 for allowing egress from bed 10′ on the foot end thereof in a manner similar to egress from an easy chair. In FIG. 16, two possible pivoting axes 11,11′ on both lateral sides of bed 10 are shown.

FIGS. 17 and 18 illustrate a variant of the bed 10 according to FIGS. 1 to 15. As far as the components of the bed 10″ shown in FIGS. 17 and 18 are of a similar construction or function as the components of the bed 10, they are provided with the same reference numerals.

The difference between the beds 10 and 10″ resides in that, in the embodiment according to FIGS. 17 and 18, the bed 10″ comprises a collapsible base 12 whose head-end-side support legs 16 are not displaceably connected to bed frame 20 while the foot-end-side support legs 14 are displaceably coupled to bed frame 20. Thus, in order to transfer the bed 10″ from its normal position according to FIG. 17 (first relative displacement position between base and bed frame) into that position (second relative displacement position) in which the foot end 23 is laterally displaceable, the base 12 will be folded together or collapsed so that the subdivision plane 44 of the mattress support structure 30 will be located outside the region occupied by the base 12 and respectively will be substantially in alignment with the foot-end-side end of base 12. All of the technical and functional features described in connection with the bed 10 according to FIGS. 1 to 15 also apply to the bed 10″ according to FIGS. 17 and 18.

Shown in FIGS. 19 and 20, finally, is a further embodiment of a bed 10′″ which is different from the embodiments of the beds 10 and 10″ in that the foot end 23 of bed 10′″ is arranged to rest on its own dedicated foot-end-side base section 12b. The second, head-end-side base section 12a is arranged to support the head-end-side bed frame section 20a and the head-end-side mattress support structure section 30a. Both base sections 12a, 12b are guided on each other for longitudinal displacement, as is also the case for the head- and foot-end-side bed frame sections and the head- and foot-end-side sections of the mattress support structure.

1. A bed, particularly a hospital bed or nursing bed, comprising
a bed frame comprising two side portions on the lateral sides, a head end, and a foot end,
a mattress support structure comprising an adjustable back section, a seat-surface section and an adjustable lower-leg section, and
a base arranged below the bed frame, said base comprising a foot-end-side end facing toward the foot end, and a head-end-side end facing toward the head end, wherein
the mattress support structure is subdivided, along a subdivision plane extending substantially parallel to the head and foot portions of the bed frame, into a foot-end-side section and a head-end-side section,
the bed frame is subdivided, along a subdivision plane extending substantially parallel to the subdivision plane of the mattress support structure, into a foot-end-side bed frame section and a head-end-side bed frame section,
the foot-end-side sections of the bed frame and of the mattress support structure are selectively lockable to their respectively associated head-end-side sections or moveable relative to said portions,
the bed frame and the base are longitudinally displaceable relative to each other, particularly in a motorized manner, in a longitudinal direction extending parallel to the side portions of the bed frame, said displacement being performed between a first and a second relative displacement position,
where, in said first relative displacement position, the subdivision plane of the mattress support structure is located in the region between the foot-end-side and head-end-side ends of the base, and
where, in said second relative displacement position, the subdivision plane of the mattress support structure is substantially in alignment with the foot-end-side end of the base or is located between the foot-end-side end of the base and the foot portion of the bed frame.

2. The bed according to claim 1, wherein the foot-end-side sections of the mattress support structure and of the bed frame are laterally displaceable beyond the lateral sides of the bed frame, with the foot-end-side sections of the bed frame band of the mattress support structure being displaceably guided on each other, particularly for lateral displacement.

3. The bed according to claim 1, wherein the foot-end-side sections of the mattress support structure and of the bed frame are laterally pivotable beyond the lateral sides of the bed frame about at least one pivot axis extending substantially vertically to the plane spread out by the bed frame.

4. The bed according to claim 3, wherein the foot-end-side sections of the mattress support structure and of the bed frame are respectively subdivided into two sections arranged on both sides of an axis, particularly a central axis, extending in the longitudinal direction of the bed frame, said sections being respectively pivotable about a pivot axis.

5. The bed according to claim 1, wherein the base is height-adjustable between a minimum height and a maximum height and that the longitudinal displaceability of the bed frame and the base is allowed when the base is located substantially at the minimum height, and/or the height adjustability of the base is allowed in case of the first relative displacement position of the bed frame and the base, and/or the height adjustability of the base is allowed up to a height slightly above the minimum height in case of the second relative displacement position of the bed frame and the base.

6. The bed according to claim 1, wherein the foot-end-side section of the bed frame is adapted to be supported on a ground surface on which the base can be positioned.

7. The bed according to claim 5, wherein on each side portion of the bed frame, between a foot-end-side and a head-end-side section of the side portion, a stiffening element is arranged which extends on both sides of the subdivision plane of the bed frame and is immersed into the two sections of each side portion when the bed frame and the base assume a relative displacement position other than the second relative displacement position.

8. The bed according to claim 7, wherein in the second relative position of the bed frame and the base, the stiffening elements can be manually actuated and thus are movable and lockable in a displacement position other than the second relative displacement position, or each stiffening element is arranged self-supporting relative to the base and is automatically released from engagement with the two foot-end-side sections of the side portions of the bed frame when the bed frame and the base assume their second relative displacement position.

9. The bed according to claim 7, wherein the stiffening elements are respectively formed as bars, that, on both sections of each side portion of the head-end-side bed frame section, a respective guiding channel is arranged for guiding the respective bar on the foot-end-side section of the side portion and a receiving channel is arranged for receiving said bar, and that, during the relative displacement of the bed frame and the base, the bars are located in the guiding and receiving channels, and, in the second relative displacement position, the bars are located outside the receiving channels.

10. The bed according to claim 1, wherein at least one locking element is provided for selective mechanical locking of the foot- and head-end-side bed frame sections so as to prevent undesired relative movement of the foot-end-side and head-end-side sections of the bed frame and the mattress support structure when the bed frame and the base are arranged in the second relative displacement position.

11. The bed according to claim 1, wherein the subdivision plane of the mattress support structure extends between the seat-surface section and the lower-leg section.

12. The bed according to claim 1, wherein the seat-surface section of the mattress support structure comprises a seat section and an adjustable upper-leg section which is arranged between said seat section and said lower-leg section, and that the subdivision plane of the mattress support structure extends between said upper-leg section and said lower-leg section.

13. The bed according to claim 1, wherein the foot-end-side sections of the bed frame and of the mattress support structure are respectively articulated to their associated head-end-side sections by means of joints having axes extending substantially parallel to the subdivision planes and transverse to the longitudinal displacement direction of the bed frame and of the base.

14. The bed according to claim 12, wherein each of said joints comprises a substantially C-shaped profiled member and a substantially cylindrical profiled member received by the latter and being displaceably guided in the substantially C-shaped profiled member.

15. The bed according to claim 12, wherein the axis of said joint extends between the two sections of the bed frame above the side portions of the bed frame.

16. The bed according to claim 1, wherein the foot-end-side section of the mattress support structure is adapted to be brought into an inclined position relative to the foot-end-side section of the bed frame by means of a scissors-type adjustable support structure, said scissors-type adjustable support structure comprising two mutually intersecting bars extending in transverse direction to the side portions of the bed frame, which bars on their ends are displaceably and rotationally connected to the foot-end-side sections of the mattress support structure and of the bed frame, and are selectively lockable in any one of a plurality of mutually intersecting inclined positions.

17. The bed according to claim 1, wherein the base is adapted to have its length adjusted relative to the bed frame in the longitudinal direction of the base parallel to the side portions of the bed frame.

18. The bed according to claim 17, wherein the base on its head-end-side end is connected to the bed frame while being secured against displacement relative to the bed frame, and on its foot-end-side end is connected to the bed frame for longitudinal displacement thereon.

19. The bed according to claim 1, wherein the base comprises a head-end-side and a foot-end-side support means having lower ends to be positioned on the ground and upper ends opposite to said lower ends, and that the head-end-side and foot-end-side ends of the base are defined by the distance between the upper ends of said head-end-side and foot-end-side support means of the base.

20. The bed according to claim 1, wherein the foot-end-side section and the head-end-side section of the bed frame are supported by a foot-end-side section and respectively a head-end-side section of the base, the bed frame and the base being connected to each other while secured against longitudinal displacement, and the foot-end-side sections of the bed frame and of the base are movable relative to each other in relation to the head-end-side sections of the bed frame and the base.
